(19) United States
(12) Patent Application Publication
(10) Pub. No.: US 2012/0274764 A1
(43) Pub. Date: Nov. 1, 2012

(54) MONITORING SYSTEM AND METHOD FOR STORING VIDEO

(75) Inventors: ZHANG-YONG ZHENG, Shenzhen City (CN); JUN-WEI ZHANG, Shenzhen City (CN); CHUNG-JEN WANG, Tu-Cheng (TW); BI-QING LUO, Shenzhen City (CN); JU-YUAN ZHANG, Shenzhen City (CN); XIN LU, Shenzhen City (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/331,417

(22) Filed: Dec. 20, 2011

(30) Foreign Application Priority Data
Apr. 29, 2011 (CN) 201110110557.7

(51) Int. Cl. H04N 7/18

(52) U.S. Cl. 348/143; 348/E07.085

(57) ABSTRACT

A monitoring system for monitoring an area, includes an image capturing module, a storage unit, and a processor. The processor controls the image capturing module to capture images within the monitored area to obtain video signal as a series of frames, and compares every two neighboring frames to determine whether the neighboring frames are the similar according to a preset reference level, and stores one of the neighboring frames in the storage unit with the number of the stored frame increased by one if the neighboring frames is determined to be similar, and stores both the neighboring frames in the storage unit if the neighboring frames are determined to be different. A method for storing video obtained by the monitoring system is also provided.

### BACKGROUND

1. Technical Field

The present disclosure relates to a monitoring system and a method for storing video obtained by the monitoring system.

2. Description of Related Art

Cameras and other sensors of monitoring systems are often mounted in shopping malls, apartments, offices, and on road intersections. Monitoring systems are intended to monitor and record around the clock what takes place in such places, so that immediate and effective measures may be taken against any improper behavior or event occurring within the monitored areas. Recorded events of the monitoring systems can also be view after the fact to verify activities that may be in dispute.

Monitoring systems generally includes a controlling unit having a memory for storing images and/or video, and an image capturing device (e.g., a camera) for electronically transmitting the captured image to the controlling unit. The captured images are received in the memory. However, some areas being monitored, such as machine rooms, warehouse, etc., may be devoid of activity at certain time during the day, such as nighttime, thus in this situation, most of the captured images are the same or similar pictures and are a waste of storage space.

Therefore, there is room for improvement in the art.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of a monitoring system in accordance with an embodiment.

FIG. 2 is a block diagram of the monitoring system of FIG. 1 in accordance with an embodiment.

FIG. 3 is a method for storing video recorded by the monitoring system of FIG. 1, in accordance with an embodiment.

FIG. 4 is a method for displaying the stored video by applying the method of FIG. 3 in accordance with an embodiment.

### DETAILED DESCRIPTION

Embodiments of the present disclosure will be described with reference to the drawings.

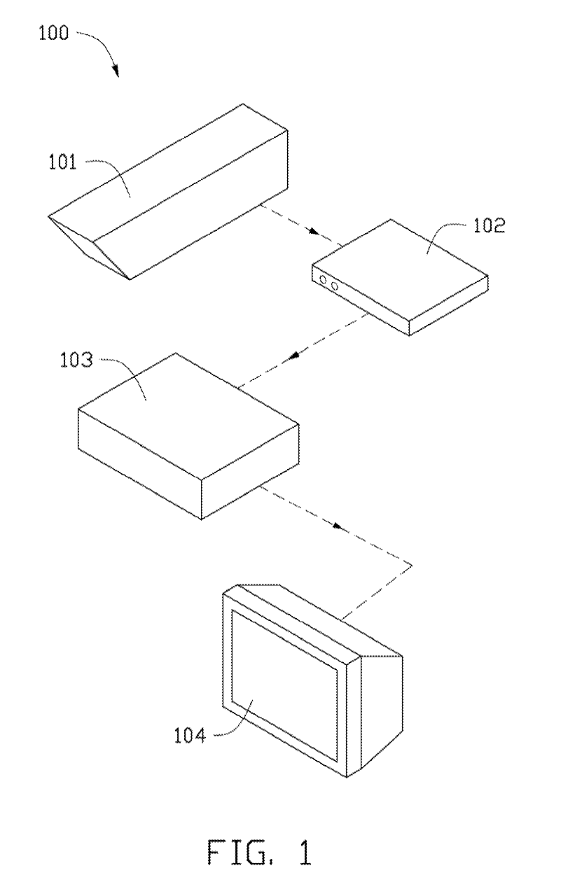

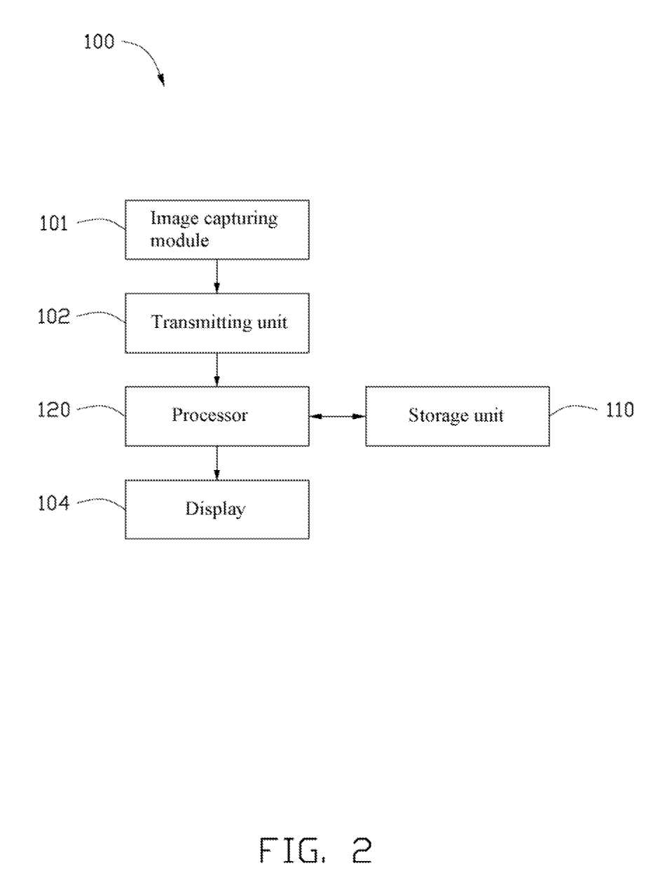

Referring to FIGS. 1-2, an embodiment of a monitoring system 100 is illustrated. The monitoring system 100 is intended to monitor and record images in the monitored area. When someone is observing the images in real time immediate measures may be taken against any improper behavior or event occurring within the monitored areas. Recorded events of the monitoring system 100 can also be view after the fact to verify activities that may be in dispute. The monitoring system 100 includes an image capturing module 101, a transmitting unit 102, a controlling unit 103 and a display 104.

The image capturing module 101 is adapted to take or record images within the monitored space to obtain a series of still frames as a video (video signals). The image capturing module 101 may be a Complementary Metal-Oxide Semiconductor (CMOS) lens.

The transmitting unit 102 is electrically connected to the image capturing module 101, and is adapted to transmit the obtained video signals to the controlling unit 103.

The controlling unit 103 is electrically connected to the transmitting unit 102, and includes a processor 120 and a storage unit 110. The storage unit 110 is used to store the captured video signals. The storage unit 110 also includes a synchronous dynamic random access memory (SDRAM) to serve as a buffer for the video signals transmitted from the transmitting unit 102. The processor 120 receives the video signals, and compares a current frame of the video signals with a next, neighboring frame (next frame) to determine whether any difference existing between the current frame and the next frame is greater or less than a preset value (which is larger than 0). In this embodiment, the processor 120 obtains the number of the pixels of each frame, and compares the obtained number of two neighboring frames to determine whether the difference between the neighboring frames is less than the preset value. When the difference between the current frame and the next frame is determined to be less than the preset value, the next frame is considered to be similar to the current frame, and the processor 120 stores the current frame with the number of the current frame increased by one, and further assigns the stored current frame as the current frame, and a frame next to the compared neighboring frames is considered to be the next frame. When the difference between the current frame and the next frame is not less than the preset value, the next frame is considered to be different from the current frame, and the processor 120 stores both the current frame and the next frame, and assigns the next frame as the current frame. Thus, when a difference between two neighboring frames of a series of frames are determined to be similar, only one of the neighboring frames with the total number of those frames are stored in the storage unit 110, whereby a very large mount of storage space is saved.

For better understanding of the present disclosure, a series of frames captured as video, including S1, S2, S3, and S4 (wherein S2 is similar to S3 but is different from S1 or S4), are taken as an example of how the captured video is saved. The series of frames including S1, S2, S3, and S4 are received and buffered in order, S1 is firstly received and serves as a current frame, the processor 120 firstly compares the current frame S1 and the next frame S2 to determine whether S1 is similar to S2. In the embodiment, as S1 is different from S2, the processor 120 stores both S1 and S2, and further assigns S2 as the current frame. Then, the processor 120 further compares the current frame S2 and a next frame S3, and because S2 is similar to S3, the current frame S2 is stored with the number of S2 is increased by one (that is, the total number of S2 is 2), and S2 is still assigned as the current frame to be compared with a next frame S4. Since S2 is different from S4, the processor 120 also stores S4. As a result, only S1, S2 with the number thereof being 2, and S4 are stored, and S3 is not saved so as to increase the storage space available in the storage unit 110.

The display 104 displays the captured video stored in the storage unit 110. The processor 120 further obtains the frames stored in the storage unit 110 in the correct order, and controls the display 104 to play the series of stored frames in order according to the number of each frame. For example, the frames S1, S2 with the number of frames being 2, and S4 in series stored in the storage unit 110 are played as follow: S1 is firstly obtained and displayed on the display 104; S2 with the number of frame being 2 is secondly obtained, at this time, because the number of the frame of S2 is 2, the processor 120 controls the display 104 to display frame S2 twice; Finally, next frame S4 is obtained and displayed. As a result, the frames stored in the storage unit 110 are displayed integrally and appear to be the actual video taken.

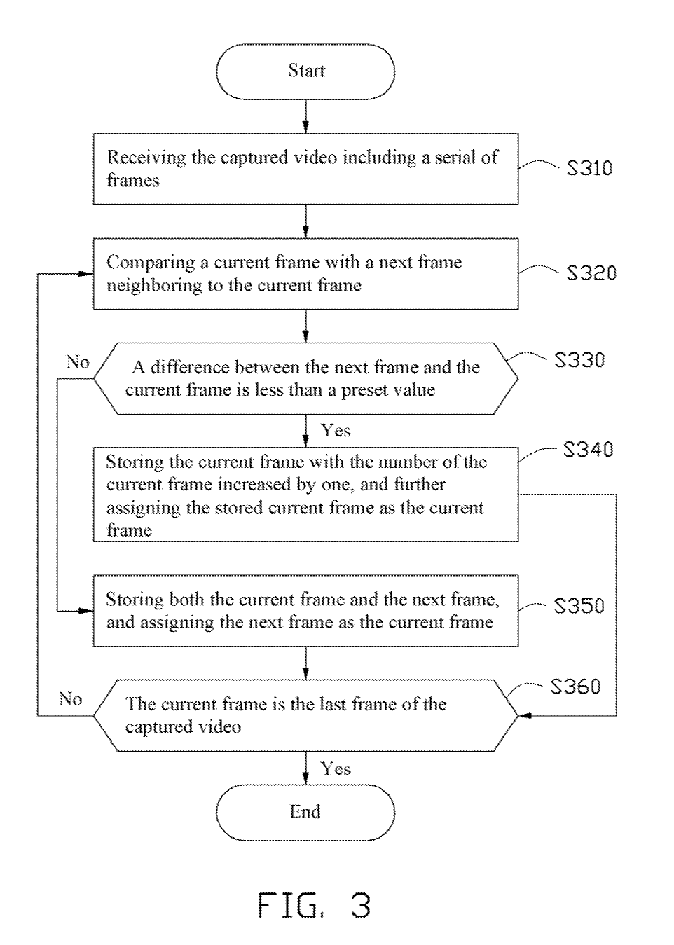

FIG. 3 is a flowchart of a method for storing video captured by the image capturing module 101 of the monitoring system 100 in accordance with an embodiment.

In step S310, the processor 120 receives the captured video including a series of frames.

In step S320, the processor 120 compares a current frame with a next frame neighboring to the current frame.

In step S330, the processor 120 determines whether a difference between the next frame and the current frame is less than the preset value. When the difference between the next frame and the current frame is less than the preset value, the procedure goes to step S340, and when the difference between the next frame and the current frame is equal to or greater than the preset value, the procedure goes to step S350.

In step S340, the processor 120 stores the current frame with the number of the current frame increased by one, and further assigns the stored current frame as the current frame.

In step S350, the processor 120 stores both the current frame and the next frame, and assigns the next frame as the current frame.

In step S360, the processor 120 determines whether the current frame is the last frame of the captured video. If it is, the procedure ends, and if it is not, the procedure returns to step S320.

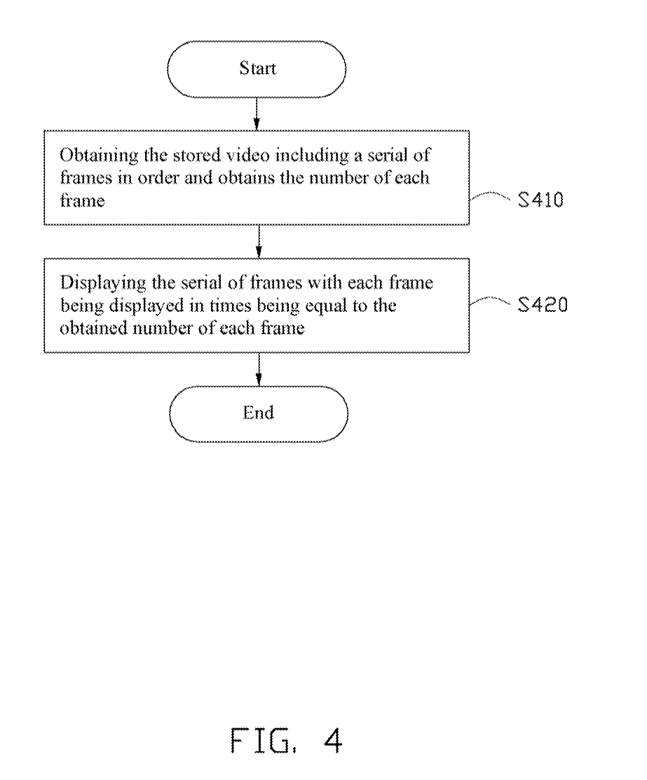

FIG. 4 is a flowchart of a method for displaying the stored video by applying the method of FIG. 3.

In step S410, the processor 120 obtains the stored frames of video including a series of frames and obtains the total number for each frame.

In step S420, the processor 120 controls the display 104 to display the series of frames with each frame being displayed N times, where N is equal to the total number of each obtained frame.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A monitoring system for monitoring an area, comprising:
an image capturing module;
a storage unit; and
a processor for controlling the image capturing module to capture images within the monitored area to obtain video signal including a series of frames, and comparing two neighboring frames to determine whether the neighboring frames are similar, and storing one of the neighboring frames in the storage unit with the number of the stored frame increased by one when the neighboring frames is determined to be similar, and storing both the neighboring frames in the storage unit when the neighboring frames are determined to be different.

2. The monitoring system as described in claim 1, further comprising a transmitting unit electrically connected to the image capturing module, wherein the transmitting unit is adapted to transmit the captured video to the processor.

3. The monitoring system as described in claim 1, wherein the processor determines whether the neighboring frames are similar by determining whether a difference between the neighboring frames reaches a preset value.

4. The monitoring system as described in claim 3, wherein the processor obtains the number of pixels of each frame, and determines the difference between neighboring frames by comparing the number of pixels between neighboring frames.

5. The monitoring system as described in claim 1, wherein the storage unit further comprises a synchronous dynamic random access memory (SDRAM) to serve as a buffer for the obtained video signals.

6. A method for storing video obtained by a monitoring system, the monitoring system for monitoring an area and comprising an image capturing module, the method comprising:
controlling the image capturing module to capture images within the monitored area to obtain video signal including a series of frames;
comparing two neighboring frames to determine whether the neighboring frames are similar;
storing one of the neighboring frames with the number of the stored frame increased by one when the neighboring frames is determined to be similar; and
storing both the neighboring frames when the neighboring frames are determined to be different.

7. The method as described in claim 6, wherein whether the neighboring frames are similar is determined by determining whether a difference between the neighboring frames reaches a preset value.

8. The method as described in claim 7, further comprising:
obtaining the number of pixels of each frame; and
comparing the number of pixels of two neighboring frames to determine whether the difference between the neighboring frames.

9. The method as described in claim 6, the step of storing one of the neighboring frames with the number of the stored frame increased by one if the neighboring frames is determined to be similar further comprising:
assigning the stored one of the neighboring frames as a current frame; and
comparing the current frame with a next frame.

10. The method as described in claim 6, the step of storing both the neighboring frames when the neighboring frames are determined to be different further comprising:
assigning the latter of the neighboring frames as a current frame; and
comparing the current frame with a next frame.

11. The method as described in claim 6, wherein the monitoring system further comprises a transmitting unit electrically connected to the image capturing module, the transmitting unit is adapted to transmit the captured video.

12. The method as described in claim 11, wherein the monitoring system further comprises a storage unit for storing the obtained video, the storage unit further comprises a synchronous dynamic random access memory (SDRAM) to serve as a buffer for the obtained video signals.
